(19) United States
(12) Patent Application Publication
(10) Pub. No.: US 2004/0216209 A1
(43) Pub. Date: Nov. 4, 2004

(54) Swimwear as information device

(76) Inventors: Robert A. Dickey, Cobble Hill (CA); Ruth A. (Jody) Stephens, Cobble Hill (CA)

Correspondence Address: Frederick Kaufman, c/o Fasken Martineau DuMoulin LLP, Suite 2100, 1075 West Georgia Street, Vancouver, BC, V6E 3G2, CA

(21) Appl. No.: 10/792,706

(22) Filed: Mar. 5, 2004

Related U.S. Application Data
(60) Provisional application No. 60/451,659, filed on Mar. 5, 2003.

(51) Int. Cl. H04Q 7/00; A41D 7/00; A41D 5/00

(52) U.S. Cl. 2/67

(57) ABSTRACT

Swimwear as an information device is provided wherein by prominently displaying international signal flags on said swimwear, a wearer can convey messages to others as prescribed by the International Code of Signals.

This application claims the benefit of U.S. Provisional Application No. 60/451,659 filed Mar. 5, 2003 which is hereby incorporated by reference.

### TECHNICAL FIELD

This invention relates in general to communication means and more particularly to communication means using clothing.

### BACKGROUND OF THE INVENTION

Clothing has been used frequently to relay messages to other individuals. These messages may include slogans (for example t-shirts bearing political messages are quite popular). In other cases the message relayed is a brand (for example a t-shirt bearing a well known trade-mark—in many cases the name of the manufacturer or retailer), in which case the wearer is sending an advertising message to those seeing the clothing. In many cases these messages have little to do with the clothing itself, and may be communicating other popular brands such as trade-marks associated with soft drinks or alcoholic beverages.

Clearly, clothing bearing a trade-mark does not send a specific message to other people, except perhaps that the user is a consumer of the products or services associated with the trade-mark. The most common way of sending a message to others via clothing is by using text or images. Images may send a message (depending on the content of the image), but it is rarely articulated precisely. The difficulty with using text on clothing to send messages is that text requires a large surface to convey sufficient information so that the text can be printed in a manner large enough to be easily read by nearby people. If the message is short enough, t-shirts and sweat shirts may provide a large enough surface to present such a text message, however, swimwear, such as swim shorts, bathing suits and bikinis generally do not.

Prior art includes U.S. Pat. No. 5,745,918 to Shukla et al., entitled “Necktie as Communication Device”, which discloses the use of a conventional neckties as a way of communicating a message. By using a necktie the size of the messages, is by necessity, quite small, and the messages are directed to the wearer of the necktie rather than to outside observers.

Other related art includes U.S. Pat. No. 6,397,390 to Henderson et al., entitled “Garment for Communicating Through Removable Messages”. This patent discloses the use of a series of removable messages for placement on a garment. As the garment is intended to be capable of holding several messages, each message must be of a relatively small size.

Yet other related prior art includes U.S. Pat. No. 5,794,267 to Wallace for “Interactive Articles of Apparel with Removeable and Interchangeable Panels”; and U.S. Pat. No. 5,632,044 to Sloot for a “Vest with Interchangeable Messages”.

One means of communication developed in the Maritime world uses maritime signal flags and pennants. These signal flags and pennants provide an international maritime code whereby ships can communicate with each other at a distance and without the crews on those ships sharing a common language. These flags and pennants, whether used singly or in combinations of several flags and pennants, are given meanings prescribed by the “International Code of Signals”, as adopted by the Fourth Assembly of the Inter-Governmental Maritime Consultative Organization in 1965, the U.S. edition of which is published by the National Imagery and Mapping Agency, (1969 edition, revised 1999, reprinted 2001), by Lighthouse Press, Annapolis, Md. and which is hereby incorporated by reference and referred to herein as the “International Code of Signals”. Of course, the language of such communication tends to be restricted to nautical terms and events such as information about cargo held by the vessel, or the movement and status of the vessel.

What is needed is a way for individuals to communicate using internationally known symbols that can be displayed on relatively small amount of clothing.

### BRIEF SUMMARY OF THE INVENTION

Apparel for communicating according to the invention is provided comprising an article of clothing prominently displaying a first international signal flag, and possibly second and/or third international signal flags. These first, second and third flags are selected from the set consisting of the flags known as “Alpha”, “Bravo”, “Charlie”, “Delta”, “Echo”, “Foxtrot”, “Golf”, “Hotel”, “India”, “Juliet”, “Kilo”, “Lima”, “Mike”, “November”, “Oscar”, “Papa”, “Quebec”, “Romeo”, “Sierra”, “Tango”, “Uniform”, “Victor”, “Whiskey”, “X-ray”, “Yankee”, Zulu”; and the pennants “One”, “Two”, “Three”, “Four”, “Five”, “Six”, “Seven”, “Eight”, “Nine”, and “Zero”. The apparel is preferably swimwear, such as a bikini, swim shorts or a t-shirt. Some examples of such apparel according to the invention include swimwear wherein said first international signal flag is “Kilo”; said first international signal flag is “Yankee”; said first international signal flag is “Uniform” and said second international signal flag is “Mike”; said first international signal flag is “Romeo” and said second international signal flag is “India”; said first international signal flag is “Romeo” and said second international signal flag is “Yankee”; said first international signal flag is “November” and said second international signal flag is “Echo”; said first international signal flag is “Zulu”, said second international signal flag is “Alpha” and said third international signal flag is “One”; or said first international signal flag is “Kilo” and said second international signal flag is “X-ray”; said first international signal flag is “Foxtrot” and said second international signal flag is “Oscar”; said first international signal flag is “Lima” and said second naval signal flag is “Zulu”; said first international signal flag is “Kilo” and said second naval signal flag is “Mike” or said first naval signal flag is “Echo” and said second naval signal flag is “Yankee”.

A method for communication is provided according to the invention comprising prominently displaying a first, and optionally second, third or fourth international signal flags on an article of clothing, said first and second international signal flags are selected from the set consisting of the flags “Alpha”, “Bravo”, “Charlie”, “Delta”, “Echo”, “Foxtrot”, “Golf”, “Hotel”, “India”, “Juliet”, “Kilo”, “Lima”, “Mike”, “November”, “Oscar”, “Papa”, “Quebec”, “Romeo”, “Sierra”, “Tango”, “Uniform”, “Victor”, “Whiskey”, “X-ray”, “Yankee”, Zulu”; and the pennants “One”, “Two”, “Three”, “Four”, “Five”, “Six”, “Seven”, “Eight”, “Nine”, and “Zero”.

### BRIEF DESCRIPTION OF THE DRAWINGS

FIG. 1 is a table of the International Signal Flags;

FIGS. 2 through 22 are examples of apparel prominently displaying international signal flags and pennants according to the invention.

Note the international signal flags are partially differentiated using the colours red, white, yellow, blue and black.

### DETAILED DESCRIPTION OF THE INVENTION

In this document, the following terms have the following meanings:

“prominently displaying” means displaying by use of a sufficient proportion of the apparel such that a signal flag or the like is plainly visible to others from a reasonable viewing distance.

“international signal flag” means a signal flag or pennant with a meaning prescribed according to the International Code of Signals and as described in the “Signal Reference”. In this document the international signal flags will be described by a full name, for example “Alfa” or “One”, rather than a shortened version, for example “A” or “1” however in either case the same meaning is conveyed, for example the flag combination “Zulu”, “Alpha” and “One”, is the same combination of flags as described by “Z-A-1”, “ZA 1” or “ZA1”.

“swimwear” means clothing designed for use with swimming or on a beach, and includes t-shirts, swim shorts, swim suits for both men and women, tankinis, bikinis, blouses, skirts, tank dress, pareos, sarongs, and towels, and accessories such as blankets, tote bags, umbrellas, and hats.

“bikini” means a two-piece bathing suit worn by women.

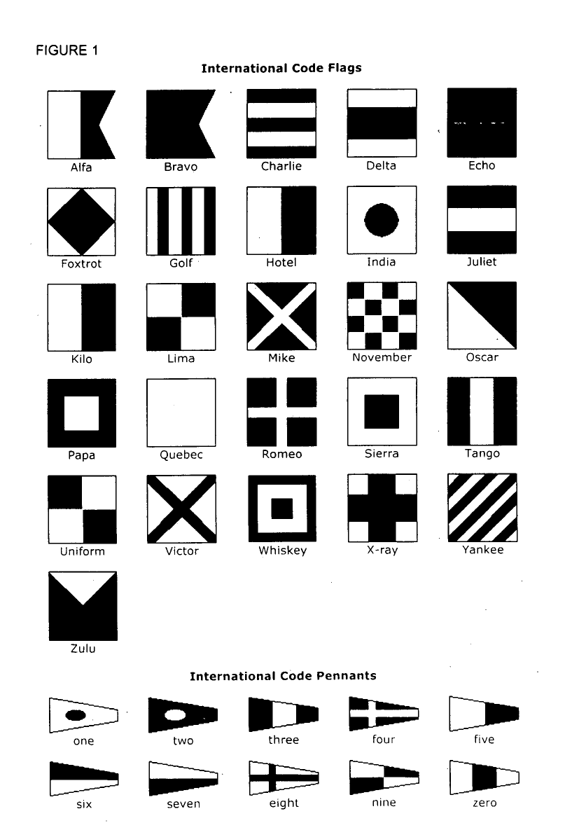

The apparel according to the invention displays international signal flags as seen in FIG. 1 to communicate with others nearby. The use of international signal flags offers several advantages. They have an aesthetic appeal as they are colourful and are attractive to wear, providing for stylish apparel. While apparel has traditionally been available in a wide variety of colors and patterns, the use of international signal flags allow the use of certain colors and patterns to have the secondary use of communication.

In FIGS. 1 to 22, colours have been indicated using the following codes:

| | |
|---|---|
| Black | Bla; |
| White | W; |
| Yellow | Y; |
| Red | R; and |
| Blue | Blu. |

In maritime use combinations of international signal flags are read and displayed from the top down. When used with apparel according to the invention, it is preferable to have the signal flags read and displayed in the same order used in reading, i.e. from left to right first and then from top to bottom, and alternatively then from front to back. In this way a message requiring three international signal flags can be displayed on a bikini, for example by displaying the first two international signal flags on the right and left bra cups and the third on the bikini bottom.

Because the international signal flags are known internationally, they do not rely on a particular language. This makes apparel with the signal flags ideal for vacationers or visitors to a location where they do not speak the local language. By using the apparel prominently displaying international signal flags according to the invention they will be able to communicate with those nearby.

The international signal flag system according to the invention uses international signal flags either singly or in combination to communicate certain phrases or information to others, combinations of flags to communicate certain phrases or information to others, such as whether or not the individual wearing the apparel is approachable. The wearer can choose to send a fairly direct message or something subtler. By using the appropriate international signal flag or combination of international signal flags, different meanings can be communicated depending on the intentions of the wearer. For example, and individual could be wearing a covering garment (e.g. a jacket or sweatshirt or the like) that prominently displays the international signal flag “X-Ray”, communicating the message “Stop carrying out your intentions and watch for my signals”. When the wearer sees someone with whom he or she would like to communicate with, the covering garment could be removed, revealing another article of apparel (e.g. a swimsuit) displaying a second international signal flag “Kilo”, communicating the message “I wish to communicate with you”.

In an alternative embodiment of the invention, the international signal flags can be detachable from the apparel. In this embodiment the international signal flags are made of a piece of fabric or the like, and may be attached to the apparel using means known in the art such as a hook and link system sold under the trade-mark VELCRO. The use of detachable international signal flags allows the wearer to send a variety of messages depending on their mood or wants, and to change the messages by deleting or adding international signal flag as necessary.

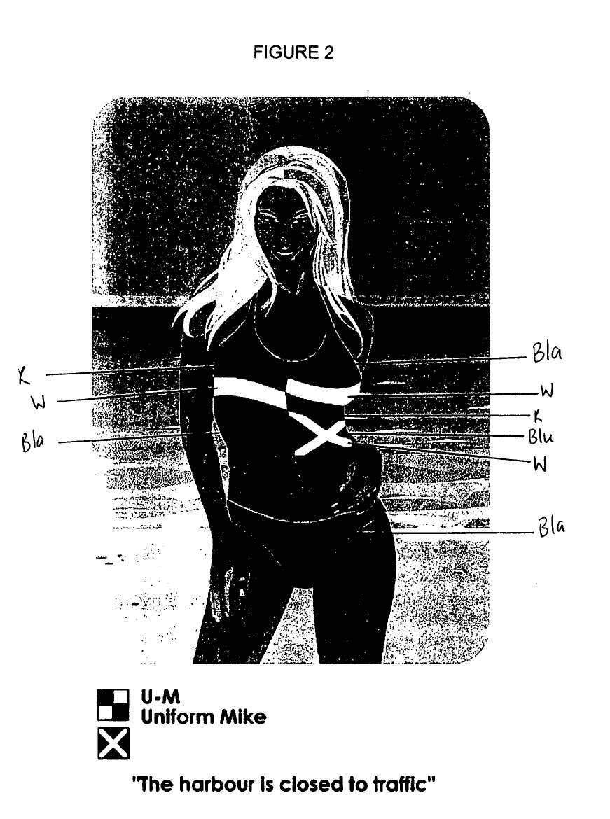

FIGS. 2 through 22 show many examples of articles of apparel which allows the wearer to communicate non-verbally to those who can see them. As can be observed in the meanings associated with the apparel, these communications are often flirtatious in nature, a consequence of the selections of the signal flags to communicate such a message.

As seen in FIG. 2, swimwear displaying the international signal flags “Uniform” and “Mike” communicates the message “The harbour is closed to traffic”.

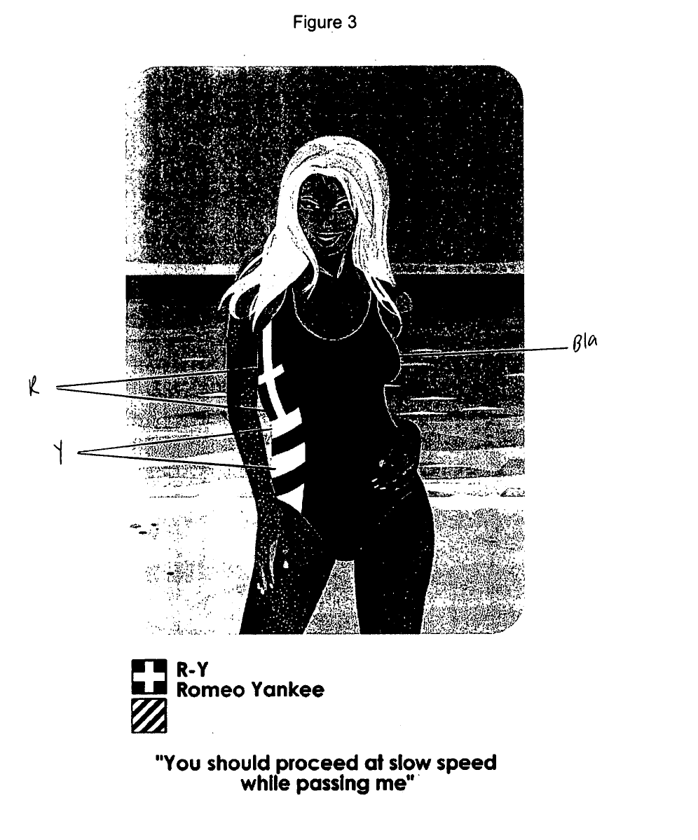

As seen in FIG. 3, swimwear displaying the international signal flags “Romeo” and “Yankee” communicates the message “You should proceed at slow speed when passing me”.

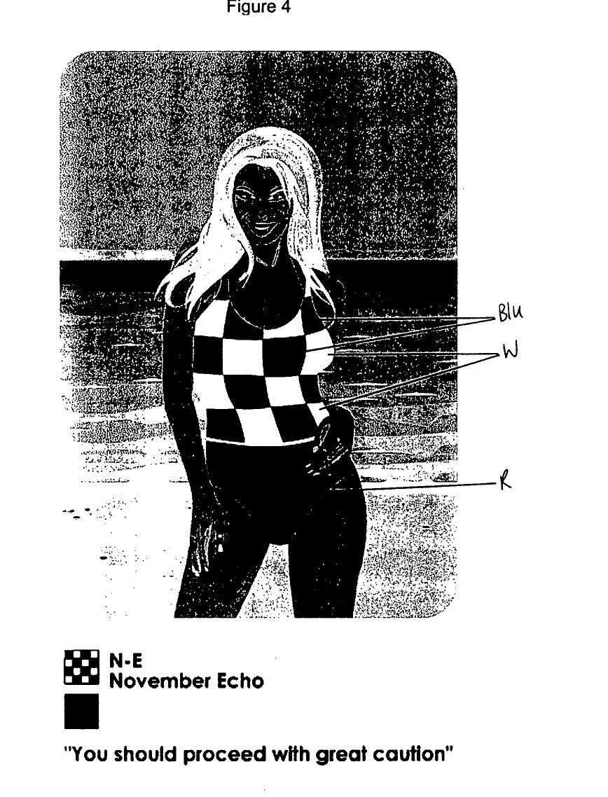

As seen in FIG. 4, swimwear displaying the international signal flags “November” and “Echo” communicates the message “You should proceed with great caution”.

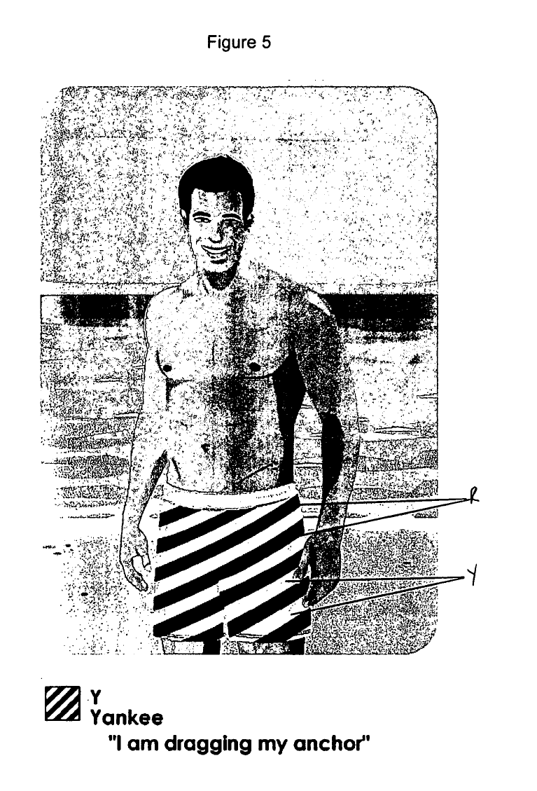

As seen in FIG. 5, swimwear displaying the international signal flag “Yankee” communicates the message “I am dragging my anchor”.

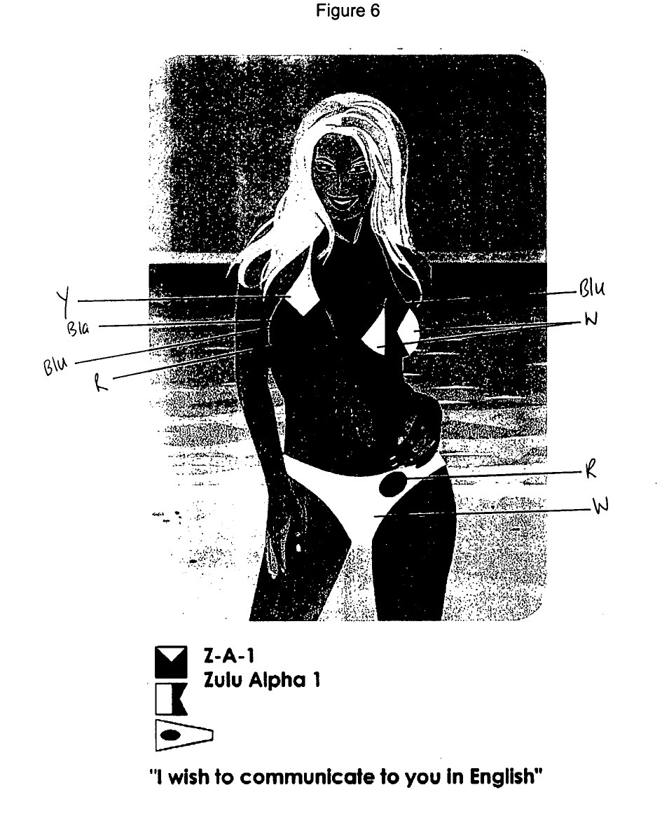

As seen in FIG. 6, swimwear displaying the international signal flags “Zulu” and “Alpha” and “One” communicates the message “I wish to communicate with you in English”. Other international signal flags can be substituted for the “One” to convey different languages. For example if the bikini bottom displayed the international signal flag “Nine” the message would convey “I wish to communicate with you in Spanish”. Likewise if the bikini bottom displayed the international signal flag “Two” the message communicated would be “I wish to communicate with you in French”.

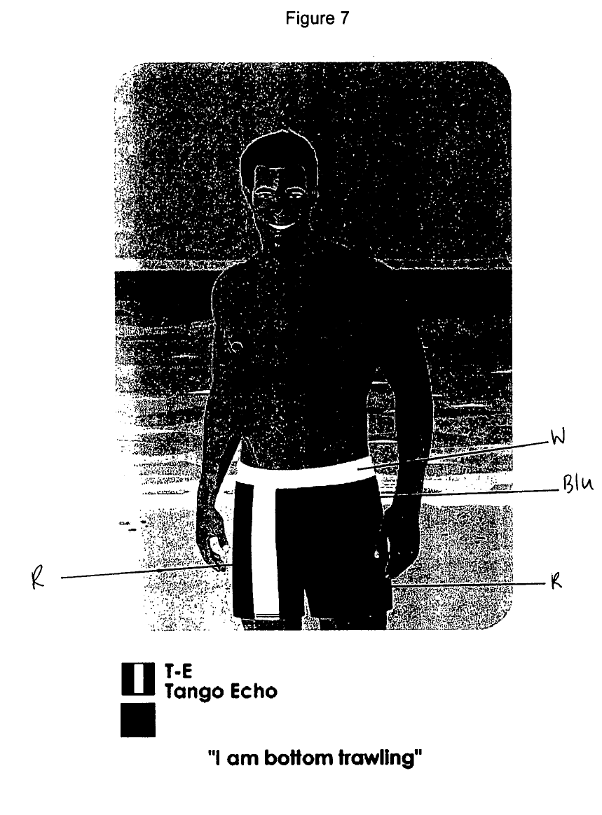

As seen in FIG. 7, swimwear displaying the international signal flags “Tango” and “Echo” communicates the message “I am bottom trawling”.

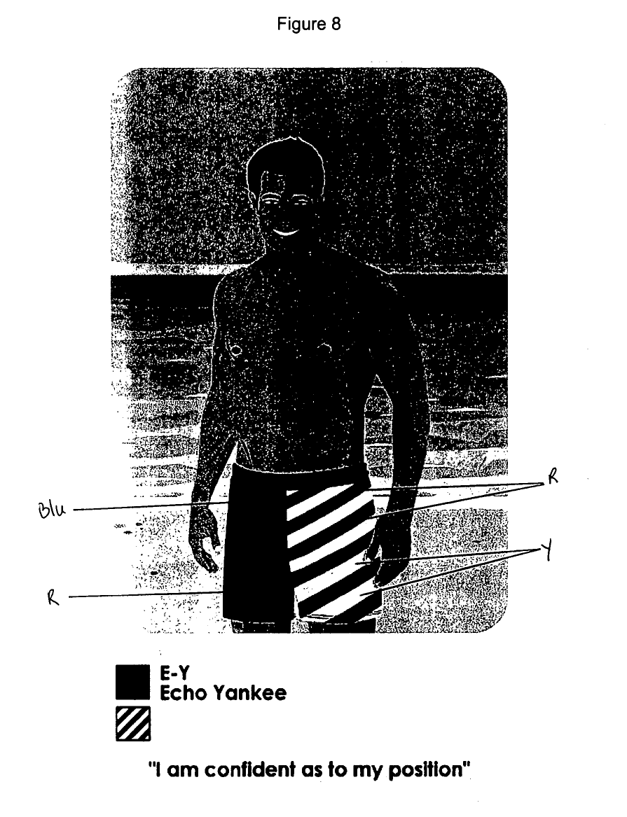

As seen in FIG. 8, swimwear displaying the international signal flags “Echo” and “Yankee” communicates the message “I am confident as to my position”.

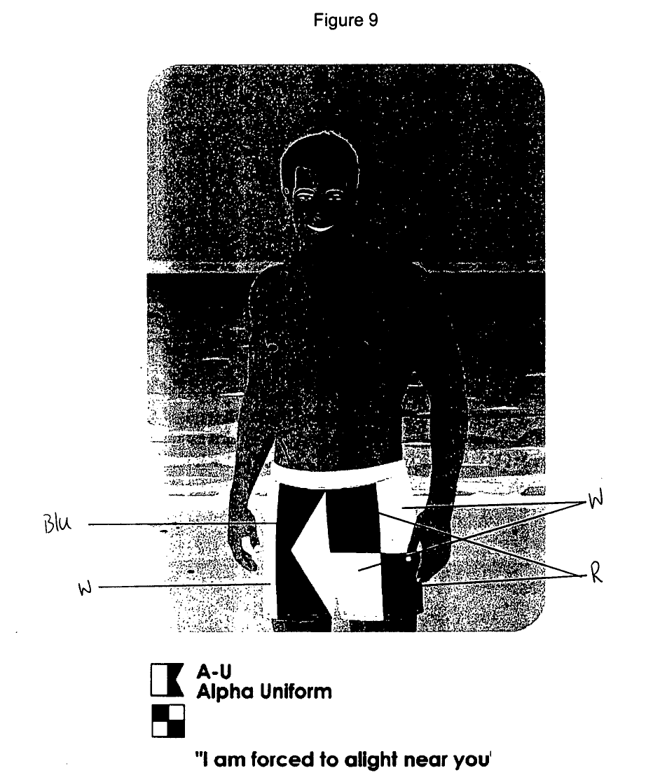

As seen in FIG. 9, swimwear displaying the international signal flags “Alpha” and “Uniform” communicate the message “I am forced to alight near you”.

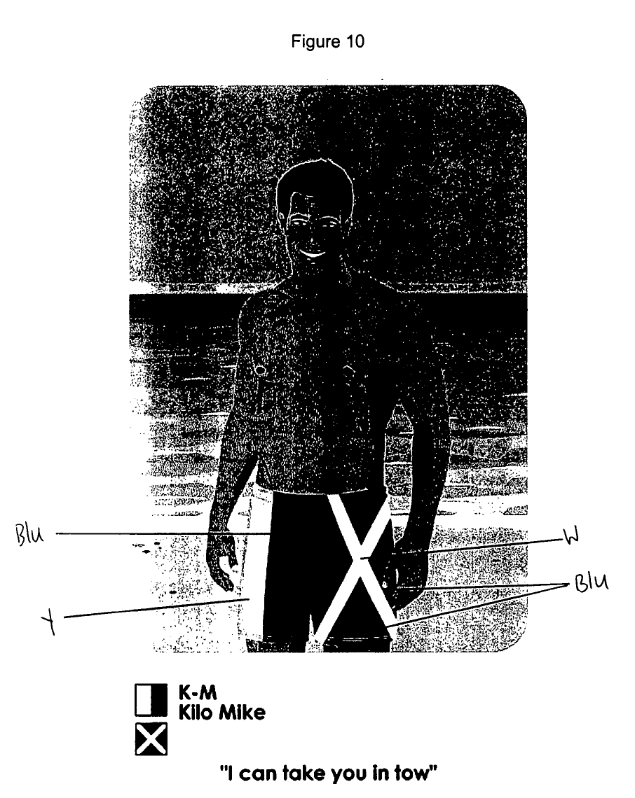

As seen in FIG. 10, swimwear displaying the international signal flags “Kilo” and “Mike” communicate the message “I can take you in tow”.

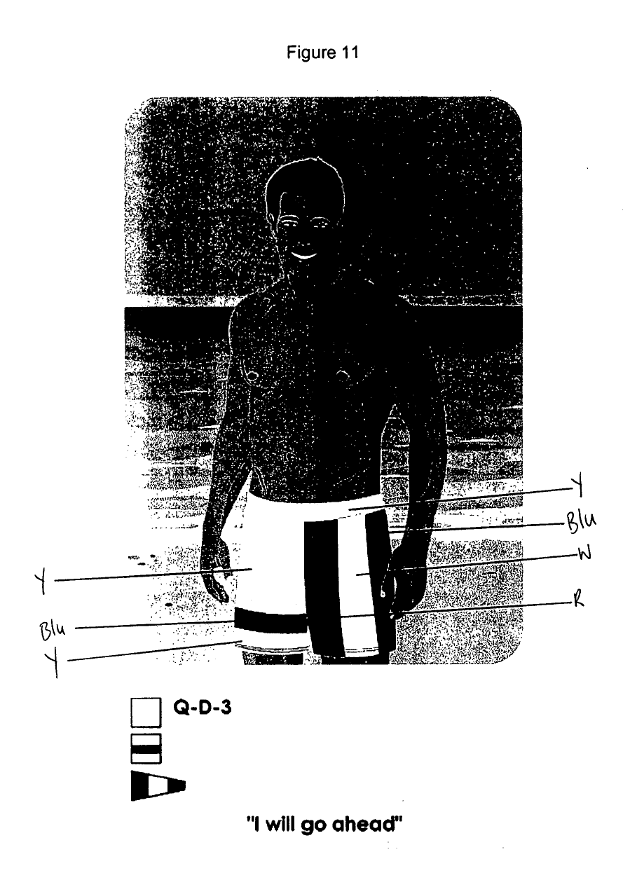

As seen in FIG. 11, swimwear displaying the international signal flags “Quebec”, “Delta” and “Three” communicates the message “I will go ahead”. Note that the wearer shown in FIG. 11 is using an alternative embodiment of the invention in which the international signal flags are read from the top down first, and then right to left.

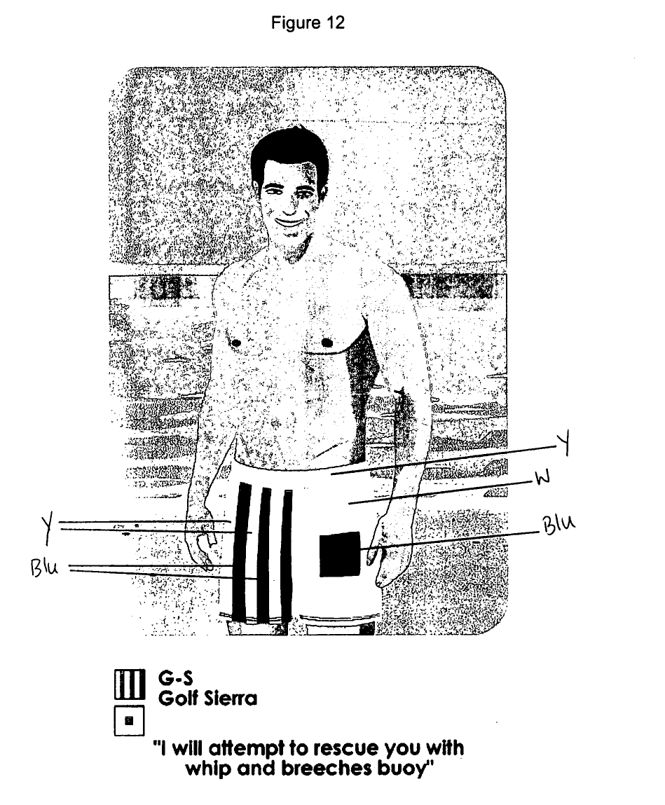

As seen in FIG. 12, swimwear displaying the international signal flags “Golf” and “Sierra” communicates the message “I will attempt to rescue you with whip and breeches buoy”.

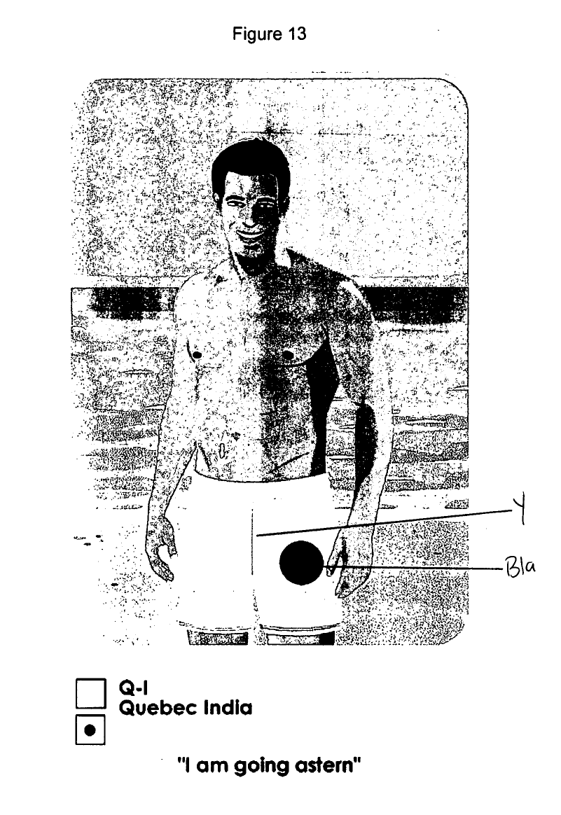

As seen in FIG. 13, swimwear displaying the international signal flags “Quebec” and “India” communicates the message “I am going astern”.

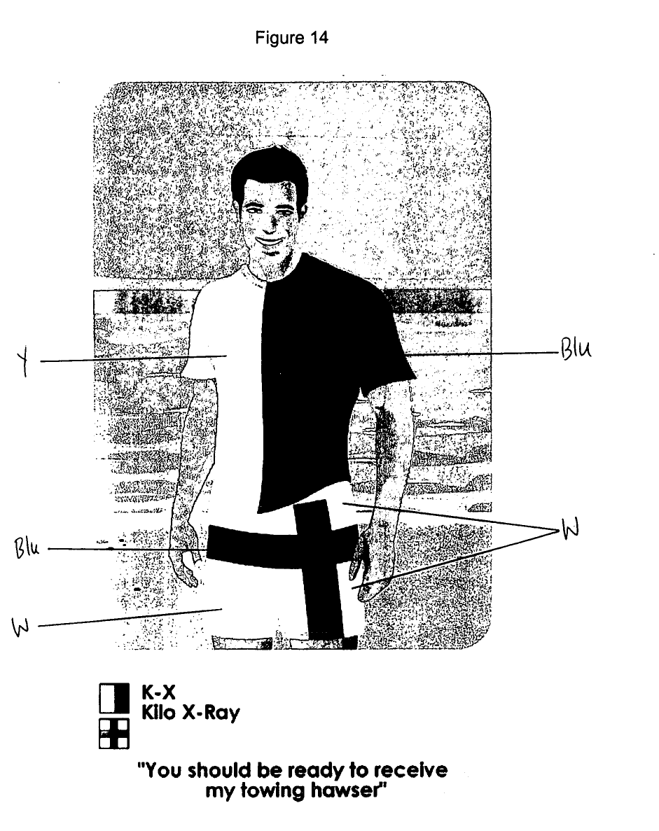

As seen in FIG. 14, swimwear displaying the international signal flags “Kilo” and “X-ray” communicates the message “You should be ready to receive my towing hawser”.

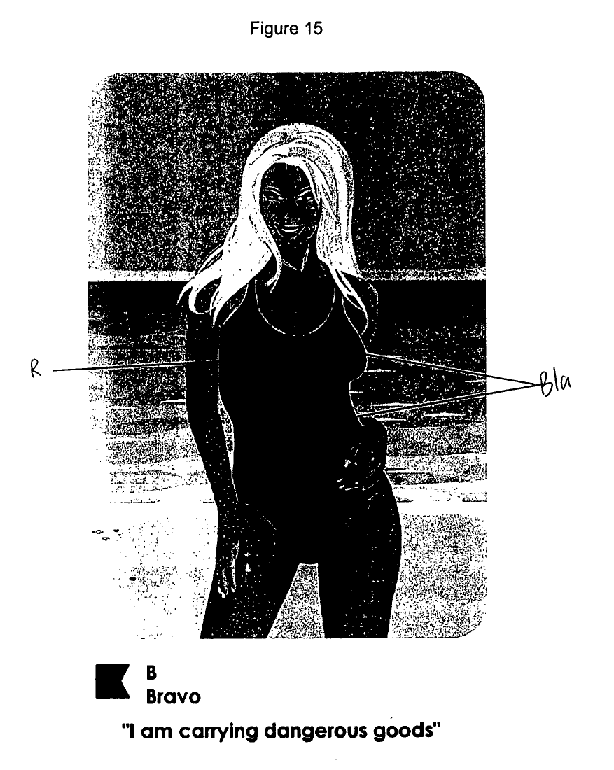

As seen in FIG. 15, swimwear displaying the international signal flag “Bravo” communicates the message “I am carrying dangerous goods”.

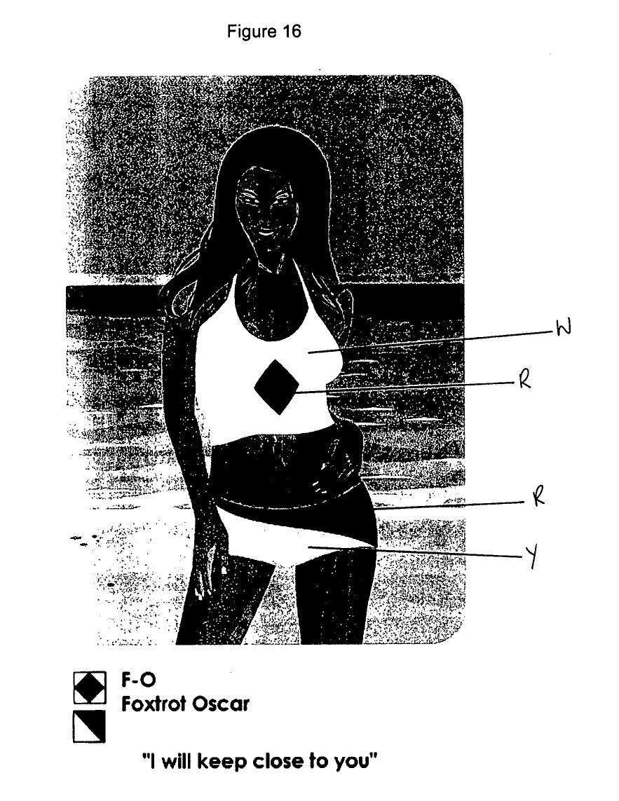

As seen in FIG. 16, swimwear displaying the international signal flags “Foxtrot” and “Oscar” communicates the message “I will keep close to you”. The addition of international signal flag “one” communicates the message “I will keep close to you during the night”.

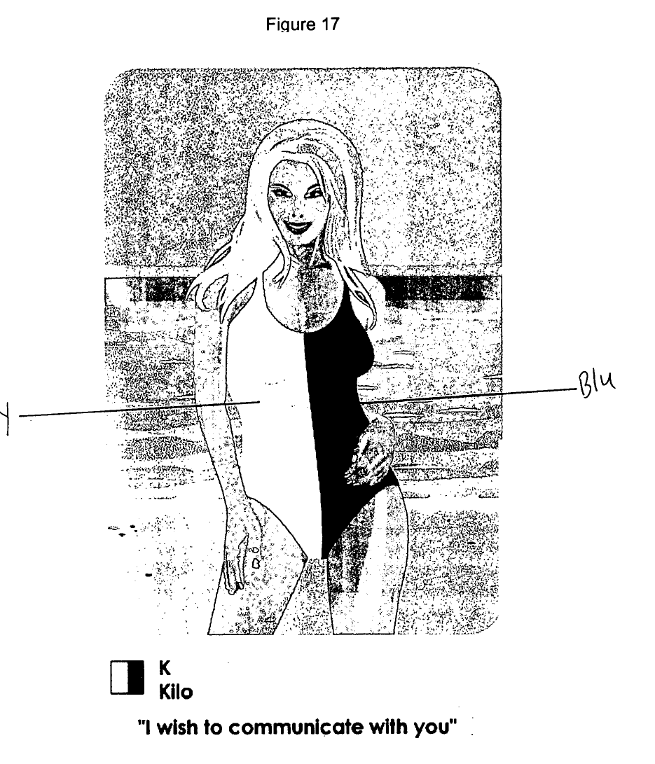

As seen in FIG. 17, swimwear displaying the international signal flag “Kilo” communicates the message “I wish to communicate with you”.

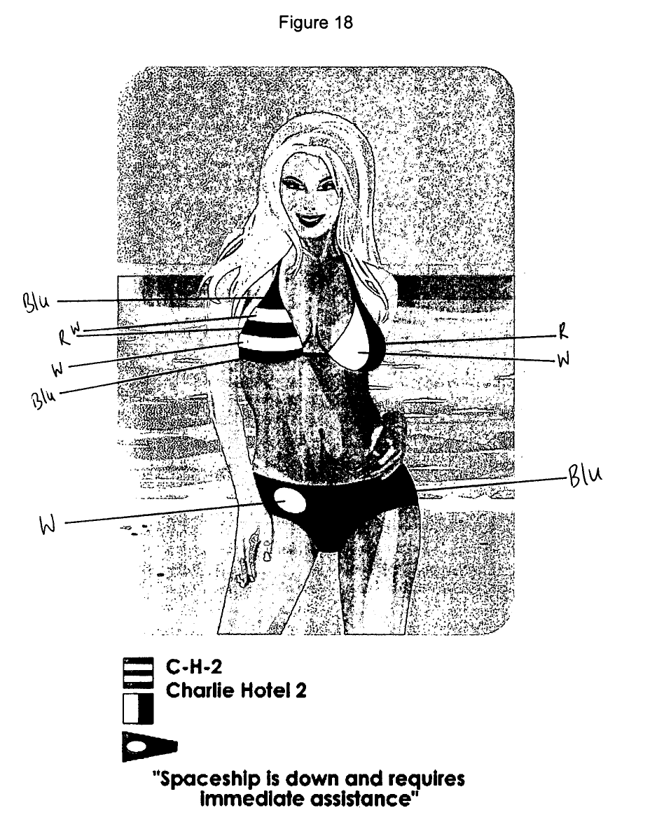

As seen in FIG. 18, swimwear displaying the international signal flags “Charlie”, “Hotel” and “Two” communicates the message “Spaceship is down and requires immediate assistance”.

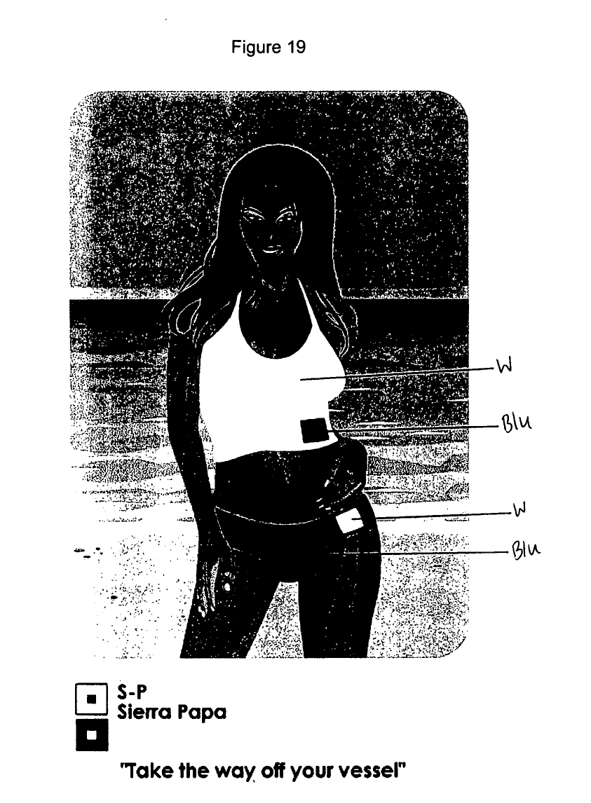

As seen in FIG. 19, swimwear displaying the international signal flags “Sierra” and “Papa” communicates the message “Take the way off your vessel”.

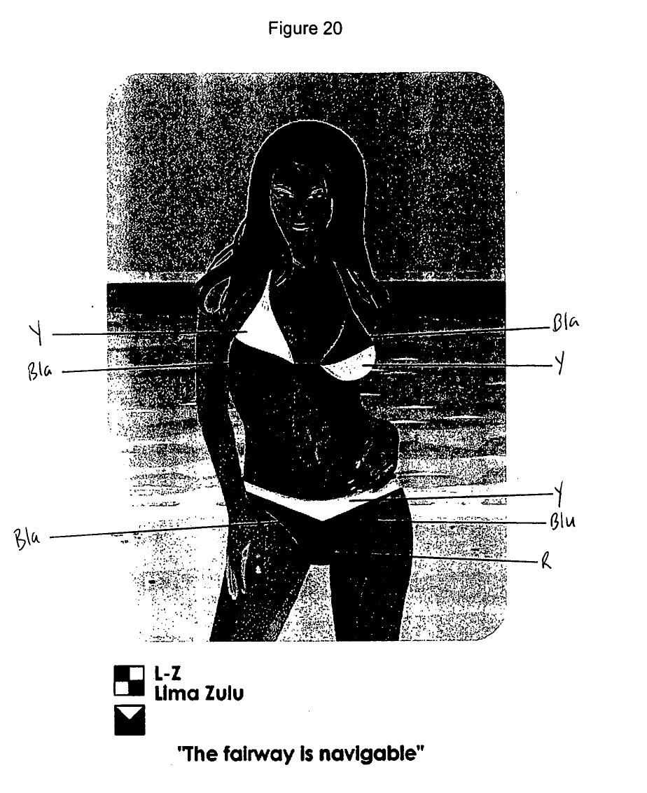

As seen in FIG. 20, swimwear displaying the international signal flags “Lima” and “Zulu” communicates the message “The fairway is navigable”.

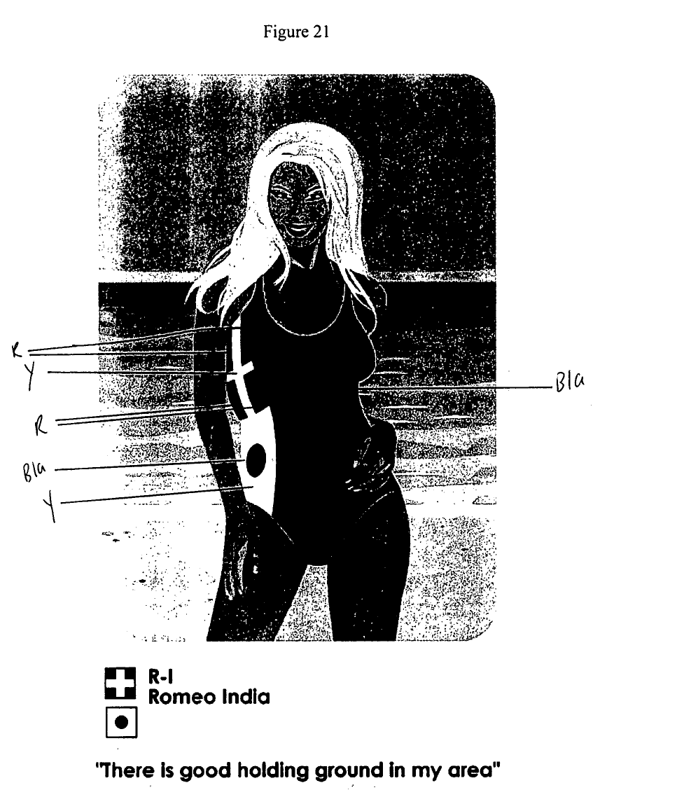

As seen in FIG. 21, swimwear displaying the international signal flags “Romeo” and “India” communicates the message “There is good holding ground in my area”.

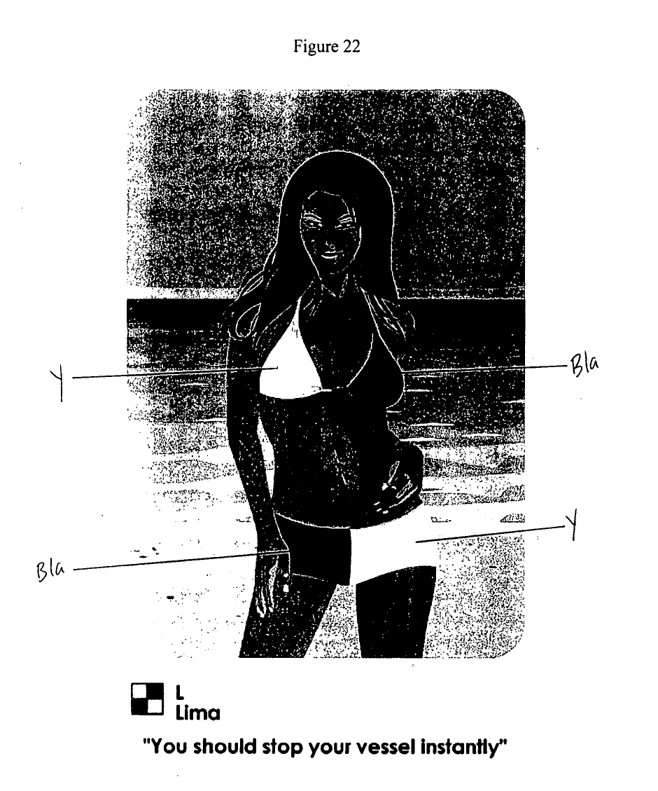

As seen in FIG. 22, swimwear displaying the international signal flag “Lima” communicates the message “You should stop your vessel instantly”.

The “International Code of Signals” describes many other combinations of international signal flags that communicate messages with appropriate meaning in day to day activity, including:

“Charlie”, “Victor” and “Three” which communicates “Can you assist me?”;

“Delta” which communicates “Keep clear of me; I am manoeuvring with difficulty”;

“Juliet” which communicates “I am on fire and have dangerous cargo on board; keep well clear of me”;

“November” which communicates “No”;

“Charlie”, “Bravo” and “Six” which communicates “I require immediate assistance; I am on fire”;

“Golf” and “Unicorn” which communicates “It is not safe to fire a rocket”;

“Golf” and “Victor” which communicates “You should endeavour to send me a line”;

“Juliet” and “Bravo” which communicates “There is danger of explosion”;

“November” and “Hotel” which communicates “You are clear of all danger”;

“Papa”, “Hotel” and “One” which communicates the message “You should steer towards me”;

“Papa” and “Papa” which communicates “Keep well clear of me”;

“Papa” and “Romeo” which communicates “You should keep closer to me

“Papa” and “Romeo” and “One” which communicates “You should come as near as possible”;

“Romeo” and “Papa” which communicates “Landing here is highly dangerous”; and

“Romeo” and “Romeo” which communicates “This is the best place to land”.

In one embodiment of the invention, apparel displaying the international signal flags may be sold with a book or a pamphlet inform the buyer or wearer of the meanings of some of the various messages that can be communicated using the international signal flags.

The international signals flags are widely known among people with experience around marine vessels. Therefore the use of the apparel according to the invention is most appropriate for locations such as yacht clubs, near ports and near naval bases, and other locations popular with boaters and others with marine expertise.

Although the particular preferred embodiments of the invention have been disclosed in detail for illustrative purposes, it will be recognized that variations or modifications of the disclosed apparatus lie within the scope of the present invention.

The invention claimed is:

1. Apparel for communicating, comprising an article of clothing prominently displaying a first international signal flag, said first international signal flag selected to convey a message prescribed by the International Code of Signals.

2. The apparel of claim 1 wherein said article of clothing further prominently displays a second international signal flag, said second international signal flag positioned to the right of or below said first international signal flag from the point of view of a distant viewer, said second international signal flag, in combination with said first international signal flag selected to convey a message prescribed by the International Code of Signals.

3. The apparel of claim 2 wherein said article of clothing further prominently displays a third international signal flag, said third international signal flag positioned to the right of or below said first and second international signal flags from the point of view of a distant viewer, said third international signal flag, in combination with said first and second international signal flags selected to convey a message prescribed by the International Code of Signals.

4. The apparel of claim 3 wherein said first, second and third international signal flags are selected from the set consisting of the flags described in the International Code of Signals as “Alpha”, “Bravo”, “Charlie”, “Delta”, “Echo”, “Foxtrot”, “Golf”, “Hotel”, “India”, “Juliet”, “Kilo”, “Lima”, “Mike”, “November”, “Oscar”, “Papa”, “Quebec”, “Romeo”, “Sierra”, “Tango”, “Uniform”, “Victor”, “Whiskey”, “X-ray”, “Yankee”, Zulu”; and the pennants “One”, “Two”, “Three”, “Four”, “Five”, “Six”, “Seven”, “Eight”, “Nine”, and “Zero”.

5. The apparel of claim 4 wherein said article of clothing is swimwear.

6. The apparel of claim 4 wherein said article of clothing is a bikini.

7. The apparel of claim 4 wherein said article of clothing is swim shorts.

8. The apparel of claim 2 wherein said first and second international signal flags are detachably securable to said swimwear.

9. The apparel of claim 1 wherein said first international signal flag is “Kilo”.

10. The apparel of claim 2 wherein said first international signal flag is “Foxtrot” and said second international signal flag is “Oscar”.

11. The apparel of claim 3 wherein said first international signal flag is “Zulu”, said second international signal flag is “Alpha”, and said third international signal flag is “One”.

12. The apparel of claim 2 wherein said first international signal flag is “Romeo” and said second international signal flag is “India”.

13. The apparel of claim 1 wherein said first international signal flag is “Lima”.

14. The apparel of claim 2 wherein said first international signal flag is “Kilo” and said second international signal flag is “Mike”.

15. The apparel of claim 1 wherein said first international signal flag is “Yankee”.

16. A method for communication comprising prominently displaying an international signal flag on apparel comprising swimwear, said first international signal flag selected to convey a message prescribed by the International Code of Signals.

17. The method of claim 16 wherein said article of clothing further prominently displays a second international signal flag, said second international signal flag positioned to the right of or below said first international signal flag from the point of view of a distant viewer, said second international signal flag, in combination with said first international signal flag selected to convey a message prescribed by the International Code of Signals.

18. The method of claim 17 wherein said first and second international signal flags are selected from the set consisting of the flags “Alpha”, “Bravo”, “Charlie”, “Delta”, “Echo”, “Foxtrot”, “Golf”, “Hotel”, “India”, “Juliet”, “Kilo”, “Lima”, “Mike”, “November”, “Oscar”, “Papa”, “Quebec”, “Romeo”, “Sierra”, “Tango”, “Uniform”, “Victor”, “Whiskey”, “X-ray”, “Yankee”, Zulu”; and the pennants “One”, “Two”, “Three”, “Four”, “Five”, “Six”, “Seven”, “Eight”, “Nine”, and “Zero”.

19. The method of claim 17 wherein said international signal flags are detachable from said swimwear.

20. The method of claim 19 wherein said swimwear is selected from the group consisting of: a bikini, swim shorts or a t-shirt.
